(19) United States
(12) Patent Application Publication
(10) Pub. No.: US 2024/0375189 A1
(43) Pub. Date: Nov. 14, 2024

(54) MODULAR JIG FOR MANUFACTURING PARTIALLY COMPLETE FIREARM PISTOL FRAME BLANK

(71) Applicant: BlackHawk Manufacturing Group Inc., Fort Worth, TX (US)

(72) Inventors: Tilden Alan Smith, Westminster, CA (US); Emmanuel Jogwe, Fort Worth, TX (US); Sheehan Hsu, Anaheim, CA (US)

(21) Appl. No.: 18/660,291

(22) Filed: May 10, 2024

Related U.S. Application Data
(60) Provisional application No. 63/501,651, filed on May 11, 2023.

(51) Int. Cl. B23B 47/28

(52) U.S. Cl. CPC B23B 47/28

(57) ABSTRACT

A modular jig which can include a passenger side wall and a driver side wall opposite the passenger side wall. The modular jig may include one or more indexable drill guides coupled to at least one of the passenger side wall and the driver side wall. The modular jig may also include a trigger guard insert coupled to each of the passenger side wall and the driver side wall. Additionally, the modular jig may include one or more magazine catch inserts coupled to an interior side of at least one of the passenger side wall and the driver side wall.

### RELATED APPLICATIONS

This application claims priority to U.S. Provisional Patent Application No. 63/501,651, filed May 11, 2023, and incorporates the same herein by reference.

### TECHNICAL FIELD

This invention generally relates to systems and methods for completing the machining of a partially completed firearm pistol blank or receiver.

### BACKGROUND

The sale and manufacture of firearms in the United States, including finished firearm pistol frames and lower receivers, are closely regulated by state and federal law. However, non-functional, unfinished pistol blanks and lower receiver blanks, often in the form of so-called “80 percent” frames or lower receiver blanks are not considered legal firearms. The legal classification of unfinished pistol frames, lower receiver blanks, finished firearm pistol frames, and lower receivers continue to evolve. Accordingly, a need exists for systems and methods for finishing the manufacture of unfinished pistol frames and lower receiver blanks into usable firearms.

### SUMMARY OF THE INVENTION

The aspects of this disclosure are directed to a reusable jig to facilitate drilling holes and milling features accurately into a nonfunctional partially completed (e.g., 80 percent) pistol frame or receiver blank. In certain aspects, the modular device described herein can aid a user to finish a pistol frame blank easily, with high quality results, and without breakage.

### BRIEF DESCRIPTION OF THE DRAWINGS

Like reference numerals are used to indicate like parts throughout the various drawing figures, wherein:

FIG. 1A is an isometric view of a modular jig and it components assembled around a pistol frame blank;

FIG. 1B is a left side view thereof;

FIG. 1C is a right side view thereof;

FIG. 2A is an isometric view of a pistol frame blank;

FIG. 2B is a left side view thereof;

FIG. 2C is a right side view thereof;

FIG. 3A is a left wall (e.g., driver side wall) of the modular jig;

FIG. 3B is an outboard side view thereof;

FIG. 3C is an inboard side view thereof;

FIG. 4A is a right wall (e.g., passenger side wall) of the modular jig;

FIG. 4B is an inboard side view thereof;

FIG. 4C is an outboard side view thereof;

FIG. 5A is an isometric view of a Picatinny rail insert module for the jig;

FIG. 5B is a front end view thereof;

FIG. 5C is a rear end view thereof;

FIG. 6A is an isometric view of an indexable drill guide module for the jig;

FIG. 6B is a first side view thereof;

FIG. 6C is a second side view thereof;

FIG. 7A is an isometric view of a trigger guard insert module for the jig;

FIG. 7B is a first side view thereof;

FIG. 7C is a second side view thereof;

FIG. 8A is an isometric view of a magazine catch insert modular for the jig;

FIG. 8B is a first end view thereof;

FIG. 8C is a second end view thereof;

FIG. 9A is an isometric view of a modular jig and its components according to another embodiment of the invention assembled around a pistol frame blank;

FIG. 9B is a left side view thereof;

FIG. 9C is a right side view thereof;

FIG. 10A is an isometric view of a left wall (e.g., driver side wall) of the modular jig;

FIG. 10B is an outboard side view thereof;

FIG. 10C is an inboard side view thereof;

FIG. 11A is an isometric view of a right wall (e.g., passenger side wall) of the modular jig;

FIG. 11B is an inboard side view thereof;

FIG. 11C is an outboard side view thereof;

FIG. 12A is an isometric view of a right side square indexable drill guide module for the jig;

FIG. 12B is a side view thereof;

FIG. 13A is an isometric view of a left side square indexable drill guide module for the jig;

FIG. 13B is a side view thereof;

FIG. 14A is an isometric view of a modular jig and its components according to a third embodiment of the invention assembled around a pistol frame blank;

FIG. 14B is a left side view thereof;

FIG. 14C is a right side view thereof;

FIG. 15A is an isometric view of a left wall (e.g., driver side wall) of the modular jig;

FIG. 15B is an outboard side view thereof;

FIG. 15C is an inboard side view thereof;

FIG. 16A is an isometric view of a right wall (e.g., passenger side wall) of the modular jig;

FIG. 16B is an inboard side view thereof;

FIG. 16C is an outboard side view thereof;

FIG. 17A is an isometric view of an indexable drill guide module for the jig;

FIG. 17B is a first side view thereof;

FIG. 17C is a second side view thereof;

FIG. 18A is an isometric view of an oval drill bushing which can be coupled to the driver side wall and the passenger side wall of the jig;

FIG. 18B is a first side view thereof;

FIG. 18C is a second side view thereof;

FIG. 19A is an isometric view of a trigger guard insert module for the modular jig;

FIG. 19B is a first side view thereof;

FIG. 19C is a second side view thereof;

FIG. 20A is an isometric view of a router milling support plate module which can couple to the driver side wall and the passenger side wall of the jig;

FIG. 20B is a left side view thereof;

FIG. 20C is a right side view thereof;

FIG. 20D is a top plan view thereof;

FIG. 20E is a bottom plan view thereof.

### DETAILED DESCRIPTION

With reference to the drawing figures, this section describes particular embodiments and their detailed construction and operation. Throughout the specification, reference to “one embodiment,” “an embodiment,” or “some embodiments” means that a particular described feature, structure, or characteristic may be included in at least one embodiment. Thus, appearances of the phrases “in one embodiment,” “in an embodiment,” or “in some embodiments” in various places throughout this specification are not necessarily all referring to the same embodiment. Furthermore, the described features, structures, and characteristics may be combined in any suitable manner in one or more embodiments. In view of the disclosure herein, those skilled in the art will recognize that the various embodiments can be practiced without one or more of the specific details or with other methods, components, materials, or the like. In some instances, well-known structures, materials, or operations are not shown or not described in detail to avoid obscuring aspects of the embodiments. “Forward” will indicate the direction of the muzzle and the direction in which projectiles are fired, while “rearward” will indicate the opposite direction. “Lateral” or “transverse” indicates a side-to-side direction generally perpendicular to the axis of the barrel. Although firearms may be used in any orientation, “left” and “right” or “driver side” and “passenger side” will generally indicate the sides according to the user's orientation, “top” or “up” will be the upward direction when the firearm is gripped in the ordinary manner.

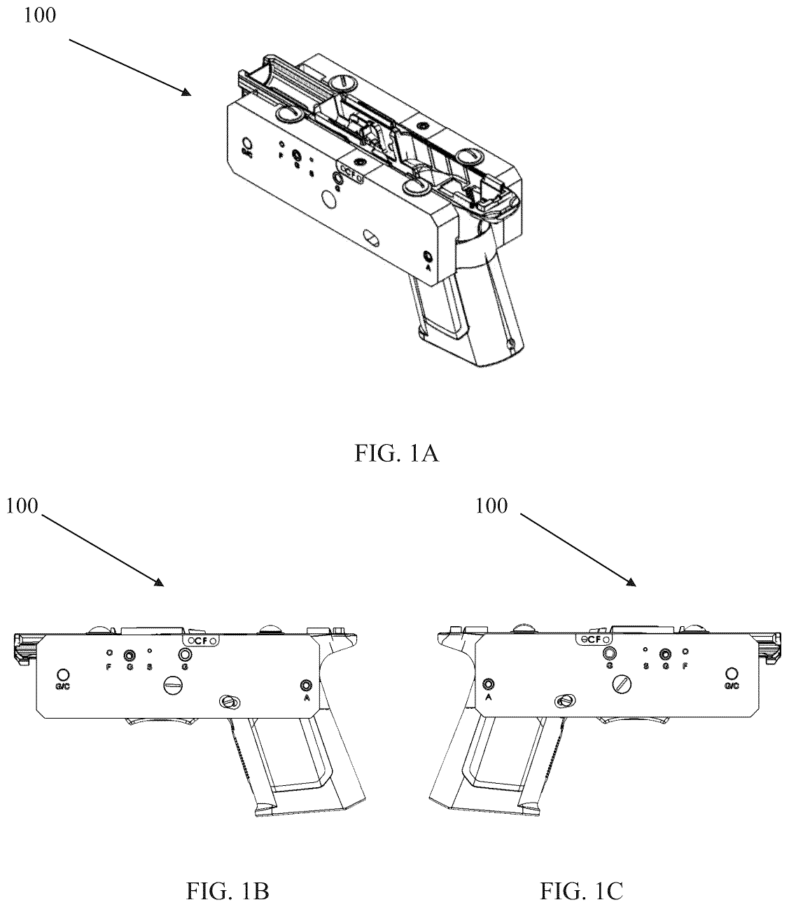

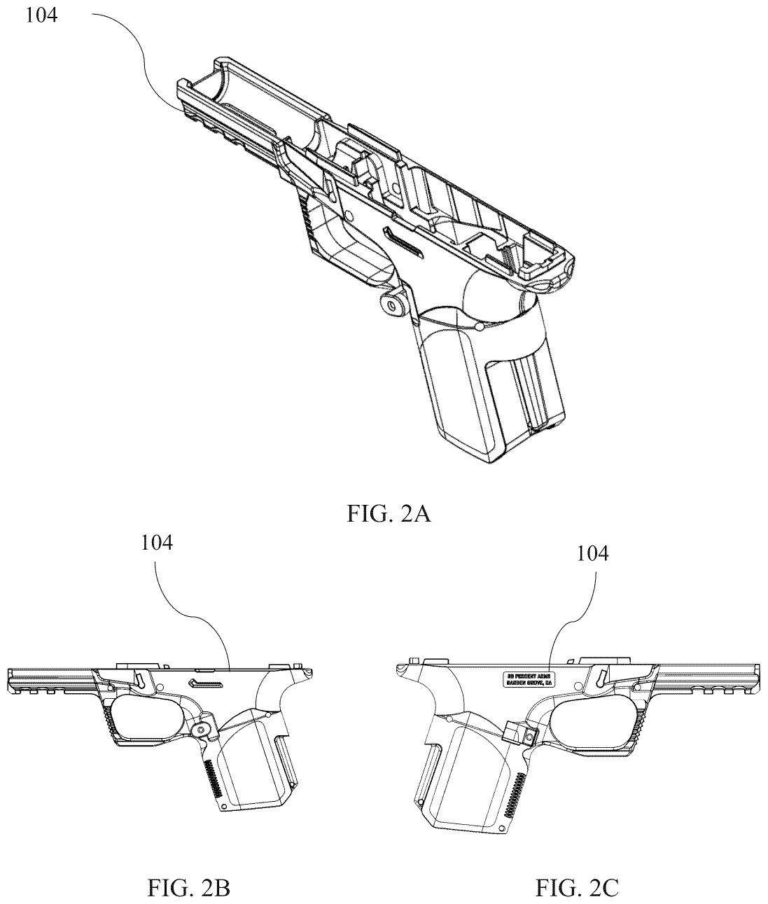

FIGS. 1A-1C show an embodiment of a modular jig 100 that can provide repeatability, accuracy, and interchangeability in the manufacturing of products. The jig 100 can be assembled around a pistol frame blank 104 to aid a user in finishing the pistol frame blank 104 (see FIGS. 2A-2C).

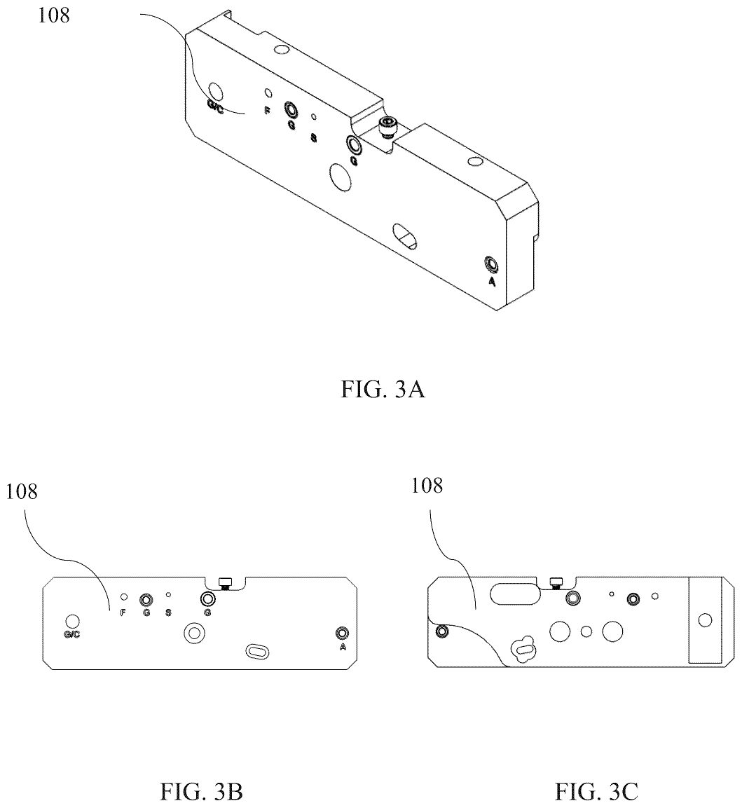

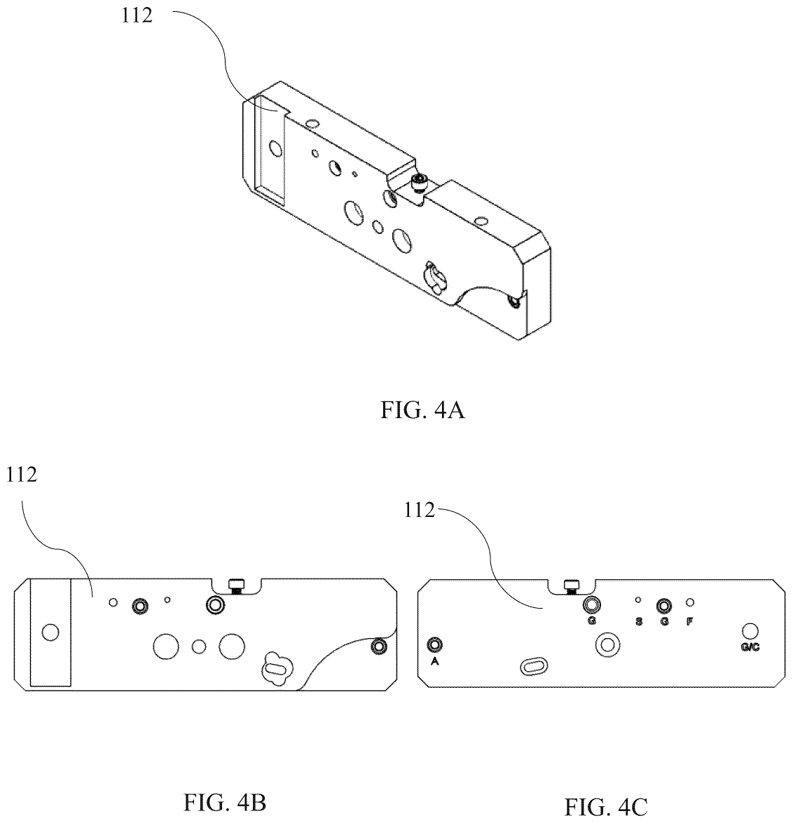

FIGS. 3A-4C show a left wall 108 (e.g., driver side wall 108) and a right wall 112 (e.g., passenger side wall 112) of the modular jig 100. The driver side wall 108 can have one or more (e.g., two) drill bushings. The one or more drill bushings can be used for drilling a trigger pin hole, a trigger housing pin hole, a locking block pin hole. The passenger side wall 112 can have one or more (e.g., two) drill bushings on a front end and a back end. The one or more drill bushings can be used for drilling a trigger pin hole, a trigger housing pin hole, a locking block pin hole. Additionally, the driver side wall 108 and the passenger side wall 112 can have multiple threaded holes located on a top portion (e.g., two threaded holes). The threaded holes located on the top portion of the driver side wall 108 and the two threaded holes located on the top portion of the passenger side wall 112 can receive fasteners (e.g., screws, screw with washers, and/or shims). An advantage of the illustrated embodiment is that the multiple threaded holes can be used to apply a downward force to the top face of the pistol frame blank and/or secure optional template tools such as a router support plate. In some embodiments, the multiple threaded holes do not receive fasteners or receive only a sub-combination of fasteners. An advantage of the illustrated embodiment is that with the multiple threaded holes the fasteners or only a portion of the fasteners can be adjusted to receive a pistol frame blank 104 with a higher or lower top shelf. Additionally, in some embodiments the driver side wall 108 and the passenger side wall 112 can have threaded holes which can be attachment points which can be used couple the optional router support plate to the walls. In some embodiments, the threaded holes can be clamping points.

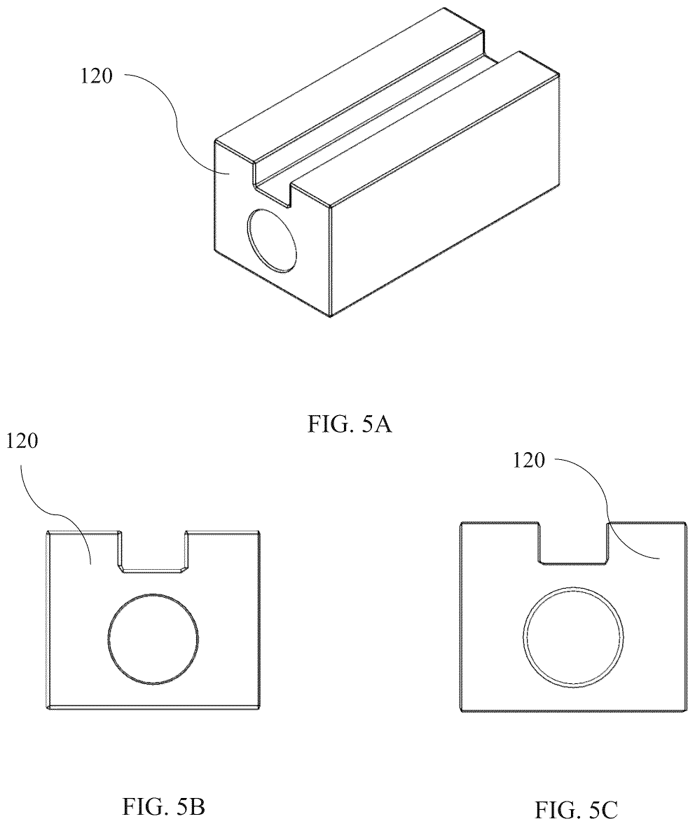

With continued reference to FIGS. 3A-4C, the driver side wall 108 can have a plurality of apertures (e.g., three). One of the plurality of apertures can be located on the front end of the driver side wall 108. The aperture located on the front end of the driver side wall 108 can receive a dowel pin which can be used to secure the driver side wall 108 to a Picatinny rail insert 120 or an accessory rail (see FIG. 5A-5C).

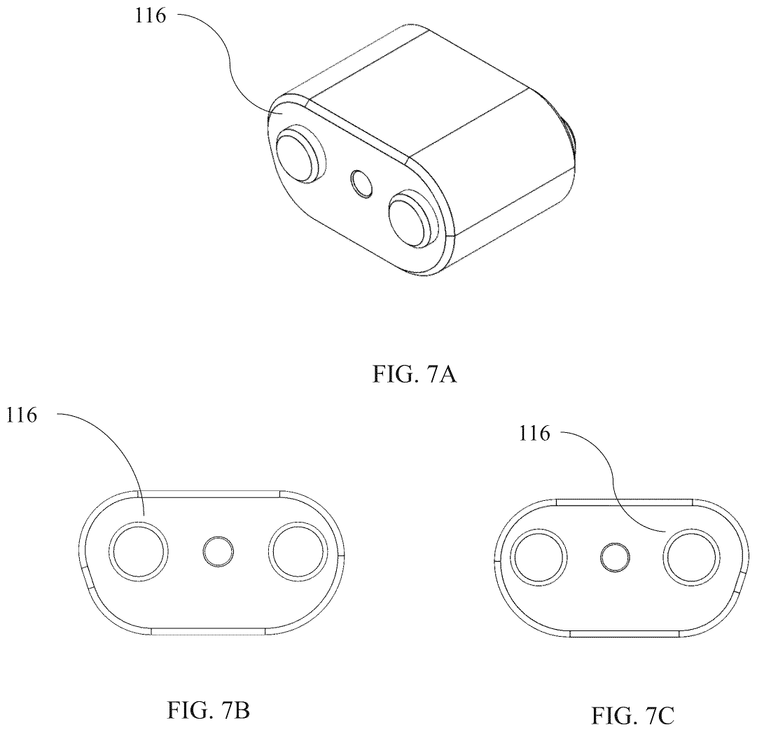

The Picatinny rail insert 120 shown in FIGS. 5A-5C can provide support and alignment for a plurality of pistol frame blanks by engaging with a rail on a lower side of the pistol frame blank 104. The remaining plurality of apertures (e.g., two) can be designed to receive dowel pins which can secure and align various different pistol frame blanks. The dowel pin can run completely through the pistol frame blank 104. The remaining plurality of apertures (e.g., two) can be located on either side of a locking block drill bushing. In some embodiments, the plurality of apertures are not used to secure the pistol frame blank to the driver side wall 108. The driver side wall 108 can have one or more cutouts. The one or more cutouts can be used to couple to a trigger guard insert 116 (see FIGS. 7A-7C).

The passenger side wall 112 can have a plurality of apertures (e.g., three). One of the plurality of apertures can be located on the front end of the passenger side wall 112. The aperture located on the front end of the driver side wall 108 can receive a dowel pin to secure a Picatinny rail insert 120. The Picatinny rail insert 120 can provide support and alignment for a plurality of pistol frame blanks by engaging with a rail on a lower side of the pistol frame blank 104. The remaining plurality of apertures (e.g., two) can be designed to receive dowel pin which can secure and align various different pistol frame blanks. The dowel pin can run completely through the pistol frame blank 104. The remaining plurality of apertures (e.g., two) can be located on either side of a locking block drill bushing. In some embodiments, the plurality of apertures are not used to secure the pistol frame blank to the passenger side wall 112. The passenger side wall 112 can have one or more cutouts. The one or more cutouts can be used to couple to a trigger guard insert 116 (see FIGS. 7A-7C).

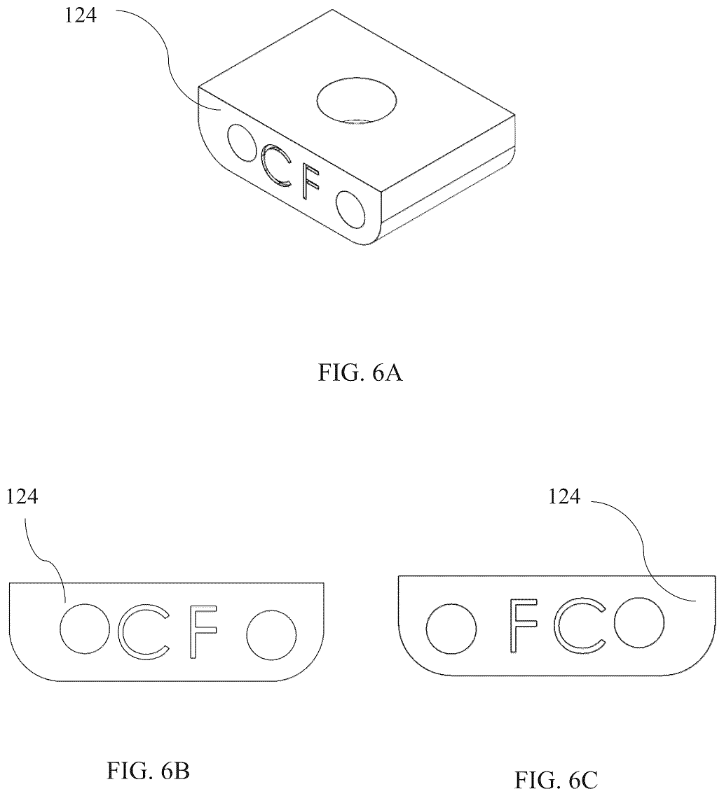

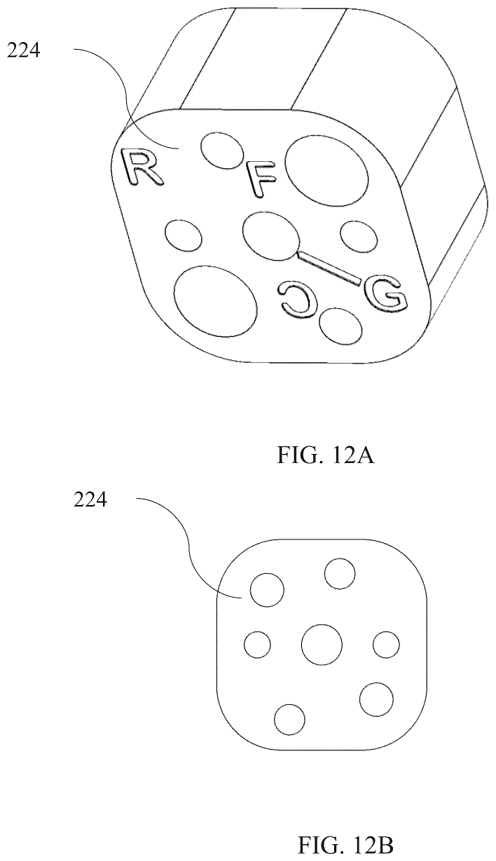

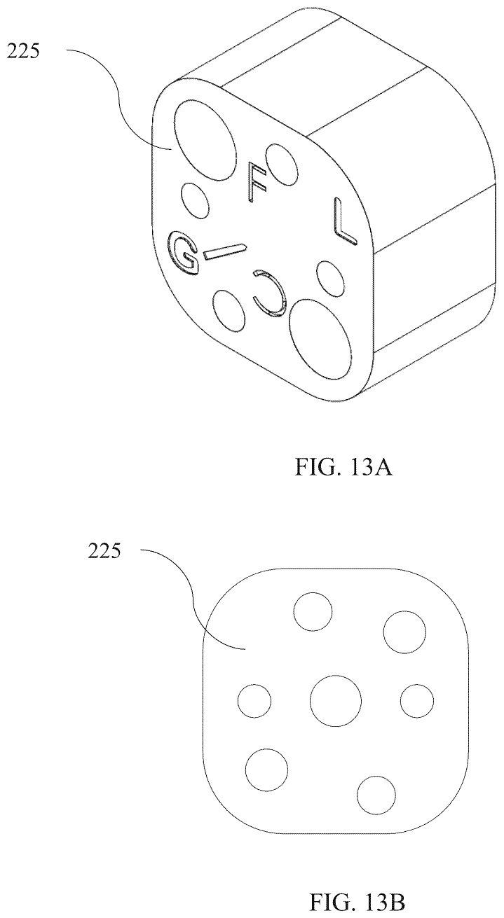

FIGS. 6A-6C show an indexable drill guide 124 (e.g., a right drill guide and a left drill guide) which can be coupled to the driver side wall 108 and the passenger side wall 112 via a cutout in each of the driver side wall 108 and the passenger side wall 112. The indexable drill guides 124 can be rectangularly shaped and rotate 180 degrees about an axis point to two different drilling positions. Alternatively, the indexable drill guides can be square shaped and rotate incrementally (e.g., incrementally rotate 90 degrees) about an axis point so that there are two or more different drilling positions (see e.g., FIGS. 12A-13B). Additionally, the drill guide can be made from hardened steel. The indexable drill guides 124 can be removably coupled to the driver side wall 108. The drill guides 124 can have one or more apertures which can be used to drill holes into the pistol frame blank 104. The indexable drill guide 124 can be rotated to a position based on the type of pistol frame blank 104 which can allow the properly sized and positioned hole to be drilled into the pistol frame blank 104. Advantageously, the indexable drill guides 124 can allow the modular jig to be assembled to various different types of pistol frame blanks.

FIGS. 7A-7C show a trigger guard insert 116 which can be coupled to the modular jig 100. The trigger guard insert 116 can provide support for the pistol frame blank 104. The trigger guard insert 116 can have one or more pegs which extend outwardly from a body portion of the trigger guard insert 116. Additionally, the trigger guard insert 116 can have one or more apertures located on the walls. The trigger guard insert 116 can be placed within an opening (e.g., trigger guard) within the pistol frame blank 104. The trigger guard insert 116 can be coupled with the driver side wall 108 and the passenger side wall 112. The one or more pegs of the trigger guard insert 116 can extend into the one or more cutouts in the driver side wall 108 and passenger side wall 112. The trigger guard insert 116 is secured to the driver side wall 108 and the passenger side wall 112 with a fastener which extends through the one or more apertures located on the walls.

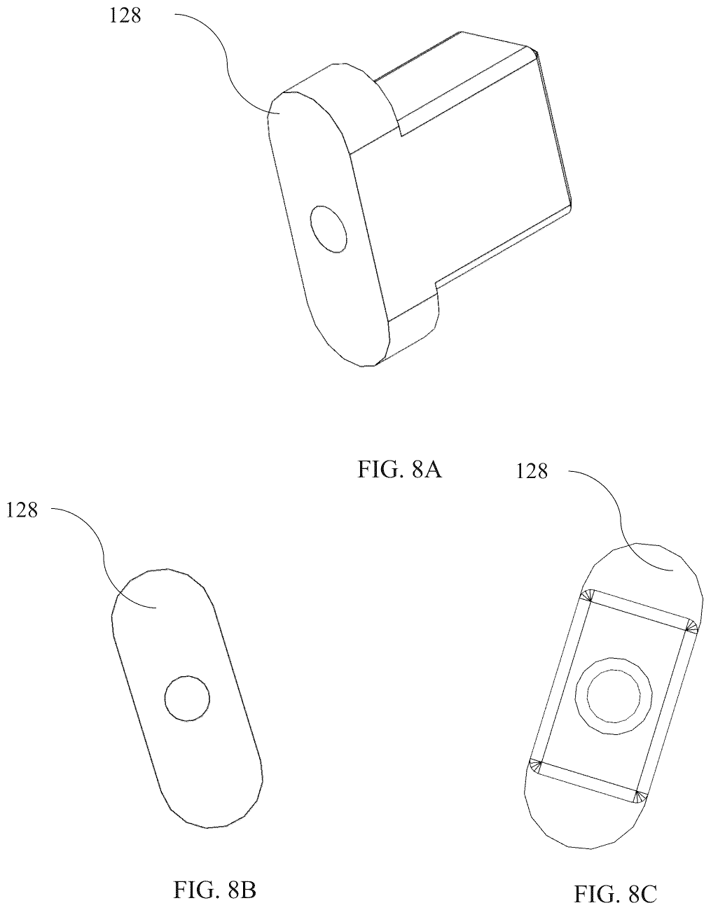

FIGS. 8A-8C show a magazine catch insert 128 for the modular jig 100. The magazine catch insert 128 can be secured to an interior face of the driver side wall 108 and the passenger side wall 112. The magazine catch inserts 128 can be used to provide additional support to the pistol frame blank 104 and to align the pistol frame blank 104 within the modular jig 100. Advantageously, the magazine catch inserts 128 are ambidextrous and can be coupled with either the driver side wall 108 and the passenger side wall 112 cutouts. Additionally, the magazine catch inserts 128 ambidextrous design facilitates installing the magazine catch insert 128 without concern for the orientation or placement of them on either the driver side wall 108 or the passenger side wall 112. When assembled to the modular jig 100, the modular jig 100 will have two magazine catch inserts 128. In some embodiments, the magazine catch inserts 128 can be designed for multiple pistol frame blanks. The magazine catch inserts 128 can be easily and quickly removed from the modular jig 100. A single fastener coupled on the driver side wall 108 through an opening and a single fastener coupled to the passenger side wall 112 through an opening are used for coupling the magazine catch inserts 128 to the modular jig 100. The magazine catch inserts 128 can protrude into magazine catch slots located on the pistol frame blank 104 to provide support and alignment.

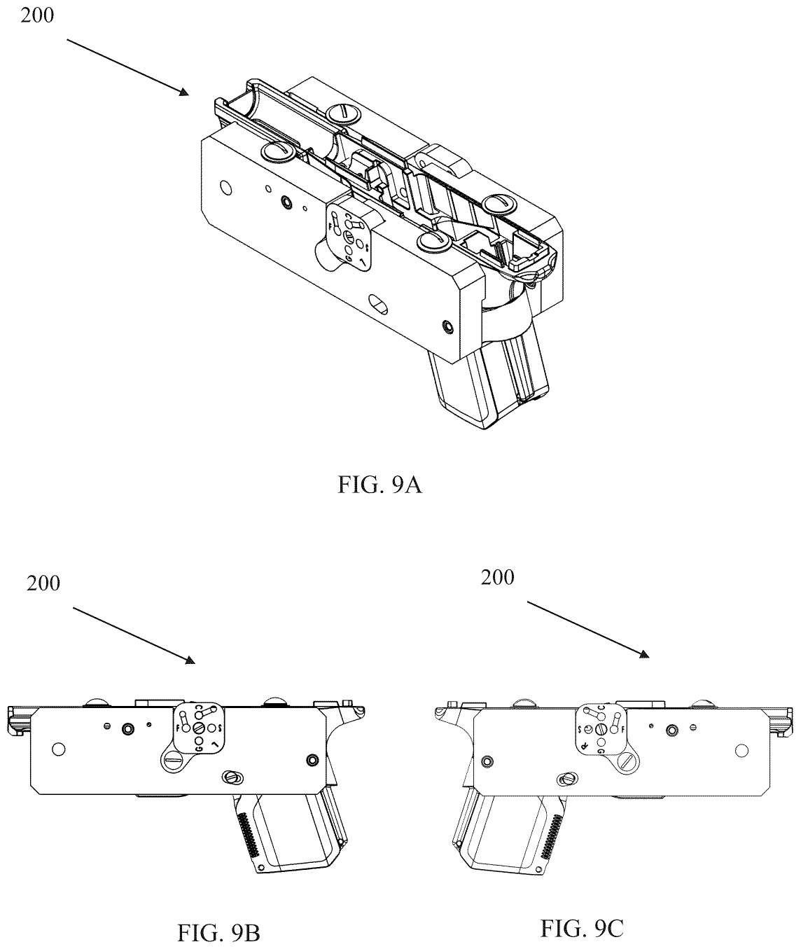

FIGS. 9A-13B show another embodiment of a modular jig 200 and its components that can provide repeatability, accuracy, and interchangeability in the manufacturing of pistol frame blanks into firearms. Some of the features and components of the modular jig 200 are similar to the features and components of the modular jig 100 in FIGS. 1A-8C. Therefore, the structure and description for the various features and components of the modular jig 100 and how it is operated and controlled in FIGS. 1A-8C are understood to also apply to the corresponding components and features of the modular jig 200 in FIGS. 9A-13B, except as described below.

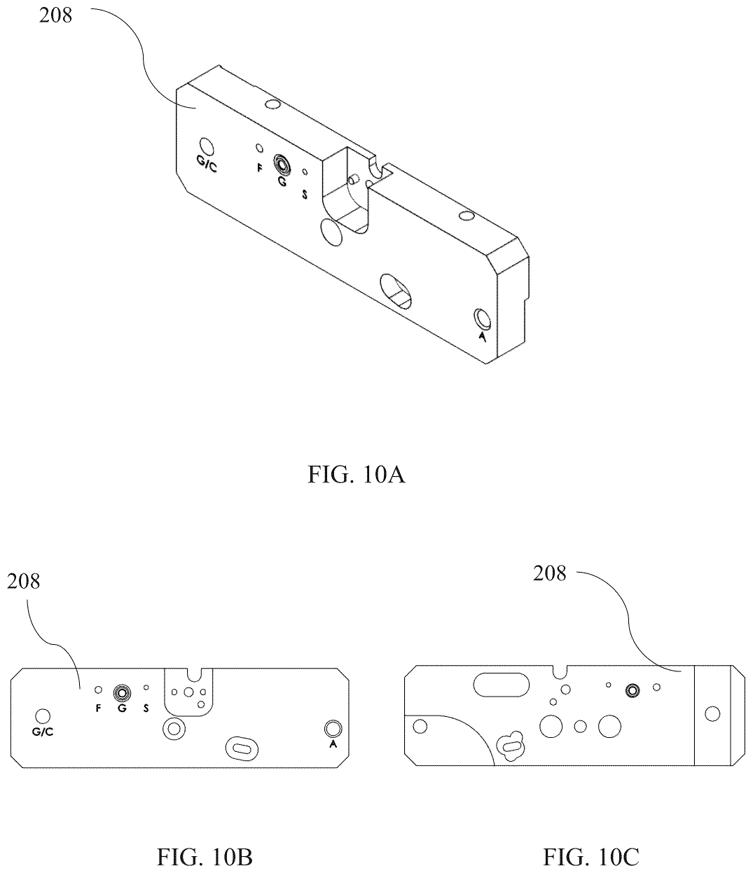

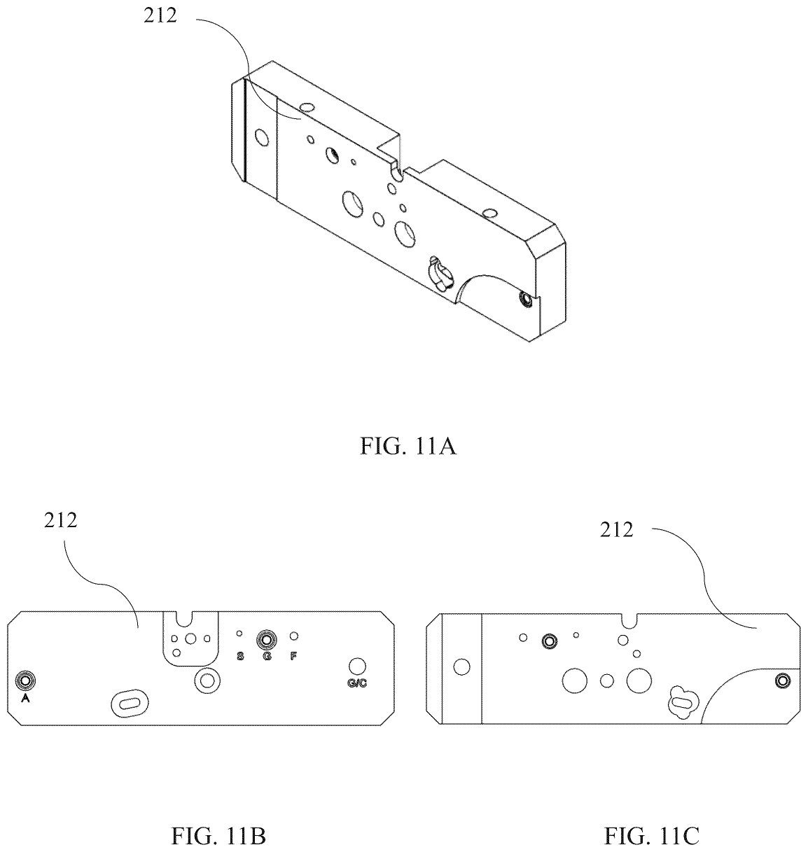

FIGS. 10A-11C show another embodiment of a left wall 208 (e.g., driver side wall 208) and a right wall 212 (e.g., passenger side wall 212) for the modular jig 200. The driver side wall 208 can have one or more (e.g., two) drill bushings on a front end and a back end. The one or more drill bushings can be used for drilling a trigger pin hole, a trigger housing pin hole, a locking block pin hole. The passenger side wall 212 can have one or more (e.g., two) drill bushings on a front end and a back end. The one or more drill bushings can be used for drilling a trigger pin hole, a trigger housing pin hole, a locking block pin hole. Additionally, the driver side wall 208 and the passenger side wall 212 can have multiple threaded holes located on a top portion (e.g., two threaded holes). The threaded holes located on the top portion of the driver side wall 208 and the two threaded holes located on the top portion of the passenger side wall 212 can receive fasteners (e.g., screws, screw with washers, and/or shims). Advantageously, the multiple threaded holes can be used to apply a downward force to the top face of the pistol frame blank and/or accommodate optional template guides such as a router milling support plate. In some embodiments, the multiple threaded holes do not receive fasteners or receive only a sub-combination of fasteners. Advantageously, when the multiple threaded holes receive no fasteners or only a portion of the fasteners the modular jig can receive a pistol frame blank 104 with a higher or lower top shelf.

FIGS. 12A-13B show a square indexable drill guide 224, 225 (e.g., a right indexable drill guide 224 and a left indexable drill guide 225) which can be coupled to the driver side wall 208 and the passenger side wall 212 via an approximately square shaped cutout in each of the driver side wall 208 and the passenger side wall 212.

The right indexable drill guide 224 can couple to the passenger side wall 212 and the left indexable drill guide 225 can couple to the driver side wall 208. The indexable drill guides 224, 225 can be rotated to four different positions by rotating the indexable drill guides 224, 225 90 degrees about an axis point. Advantageously, this allows for the indexable drill guides 224, 225 to be used on various different types of pistol frame blanks.

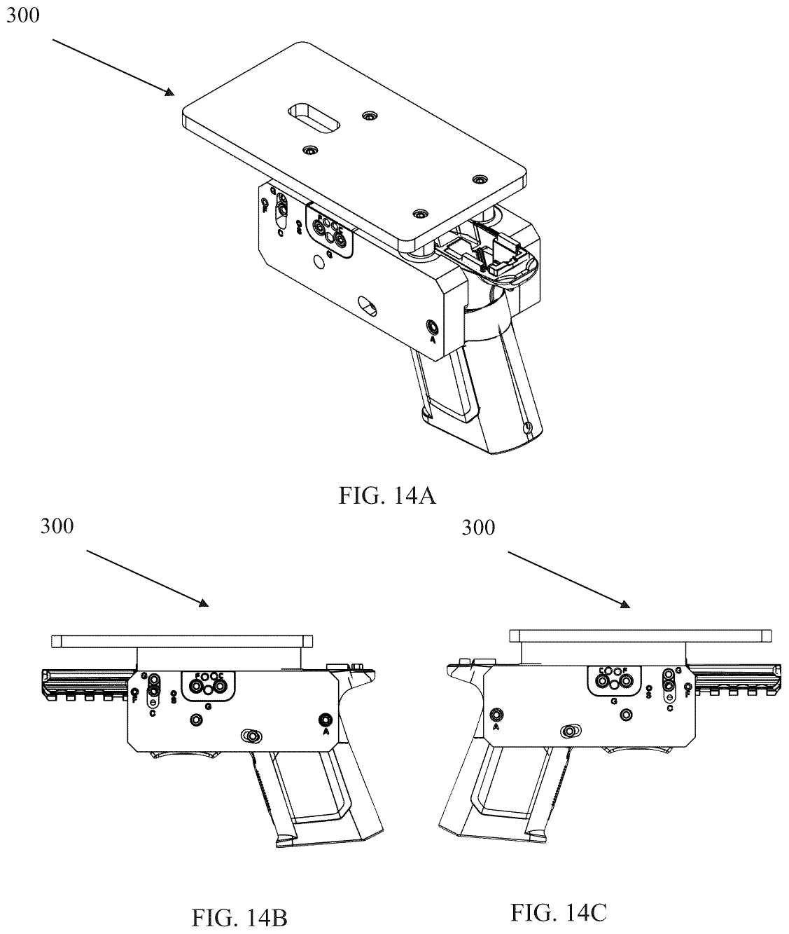

FIGS. 14A-20E show another embodiment of a modular jig 300 and its components that can provide repeatability, accuracy, and interchangeability in the manufacturing of pistol frame blanks into firearms. Some of the features and components of the modular jig 300 are similar to the features and components of the modular jig 100 shown in FIGS. 1A-8C. Therefore, the structure and description for the various features and components of the modular jig 100 and how it is operated and controlled in FIGS. 1A-8C are understood to also apply to the corresponding components and features of the modular jig 300 in FIGS. 14A-20E, except as described below.

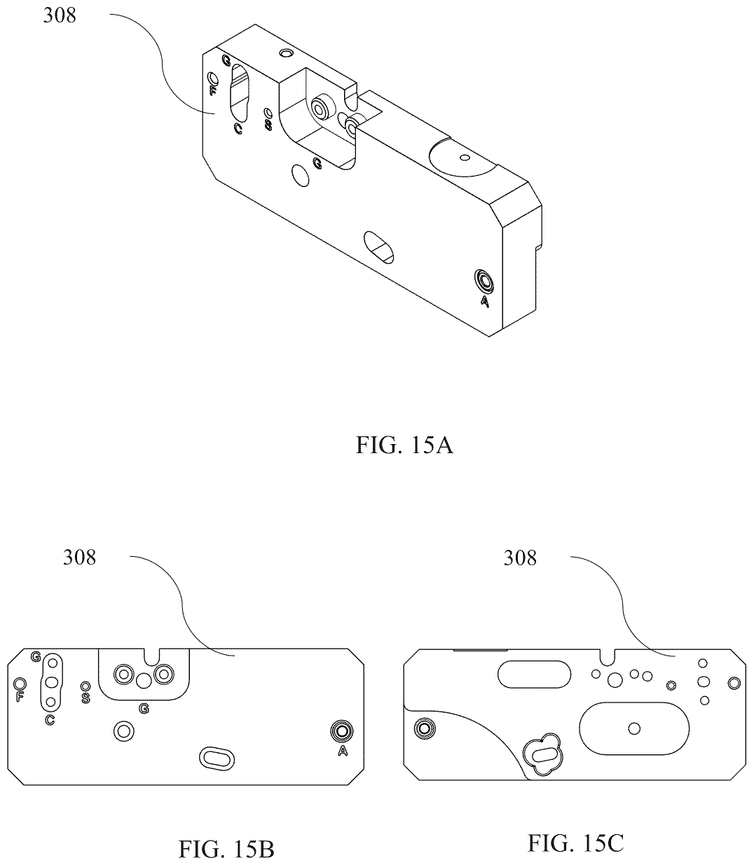

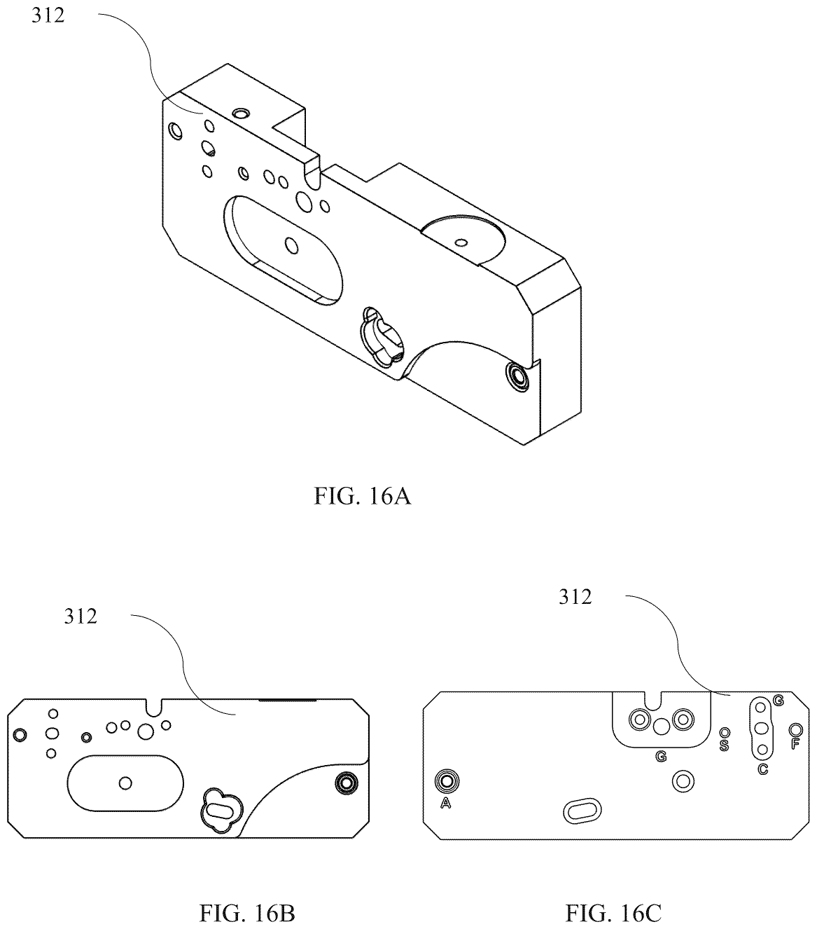

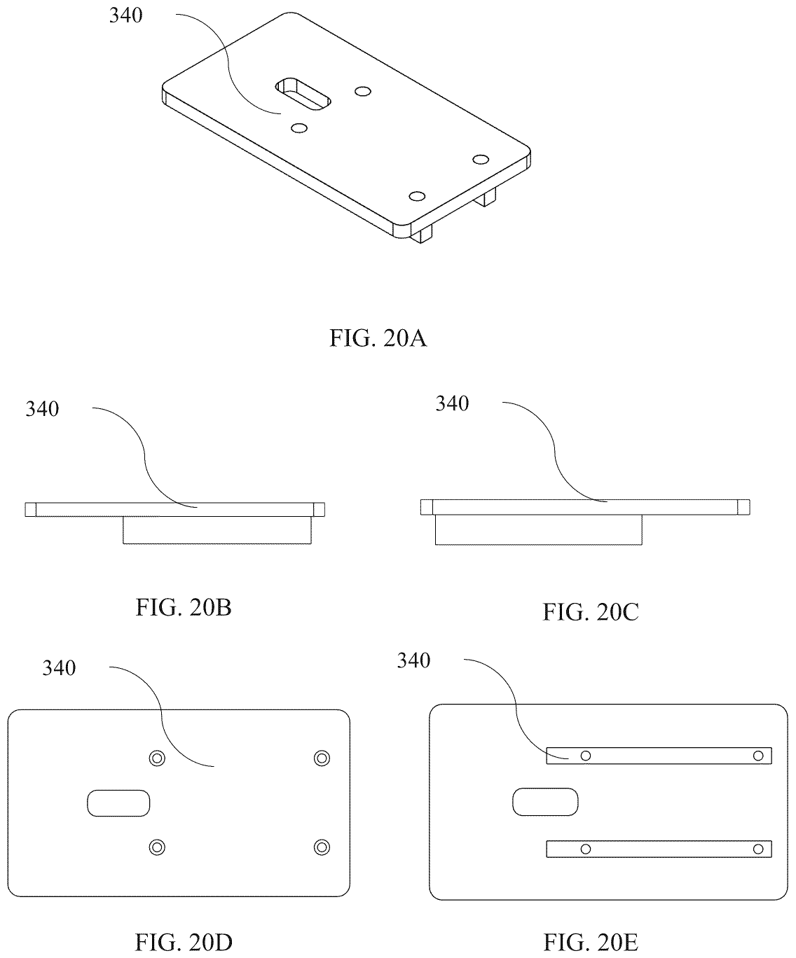

FIGS. 15A-16C show another embodiment of a left wall 308 (e.g., driver side wall 308) and a right wall 312 (e.g., passenger side wall 312) for the modular jig 300. The driver side wall 308 can have one or more (e.g., two) drill bushings on a front end and a back end. The one or more drill bushings can be used for drilling a trigger pin hole, a trigger housing pin hole, a locking block pin hole. The passenger side wall 312 can have one or more (e.g., two) drill bushings on a front end and a back end. The one or more drill bushings can be used for drilling a trigger pin hole, a trigger housing pin hole, a locking block pin hole. Additionally, the driver side wall 308 and the passenger side wall 312 can have multiple threaded holes located on a top portion (e.g., two threaded holes). The threaded holes located on the top portion of the driver side wall 208 and the two threaded holes located on the top portion of the passenger side wall 312 can receive fasteners (e.g., screws, screw with washers, and/or shims). An advantage of the illustrated embodiment is that the multiple threaded holes can be used can be used to couple the passenger side wall 312 and the driver side wall 308 to a router milling support plate (see FIGS. 20A-20E). Additionally, the driver side wall 308 and the passenger side wall 312 can have one or more apertures located on the inner side of the wall which can partially extend through the wall and can receive a dowel pin.

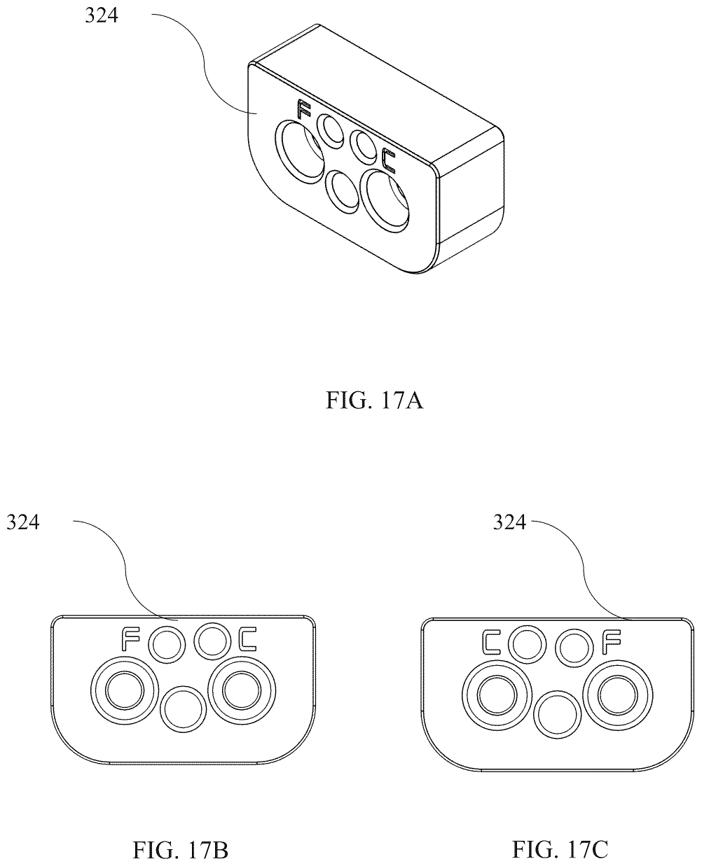

FIGS. 17A-17C show an indexable drill guide 324 (e.g., a right drill guide and a left drill guide) which can be coupled to the driver side wall 308 and the passenger side wall 312 via a cutout in each of the driver side wall 308 and the passenger side wall 312. The indexable drill guides 324 can be interchangeable and can couple with either of the driver side wall 308 and the passenger side wall 312. Additionally, the drill guide 324 can be made from hardened steel. The indexable drill guides 324 can be removably coupled to the driver side wall 308. The drill guides 324 can have one or more apertures (e.g., three) which can be used to drill holes into the pistol frame blank 104. The indexable drill guide 314 can eliminate a need for a drill bushing in the driver side wall 308 and the passenger side wall 312. The indexable drill guide 324 can be rotated to a position based on the type of pistol frame blank 104 which can allow the properly sized hole to be drilled into the pistol frame blank 104. Advantageously, the indexable drill guides 324 can allow the modular jig to be assembled to various different types of pistol frame blanks.

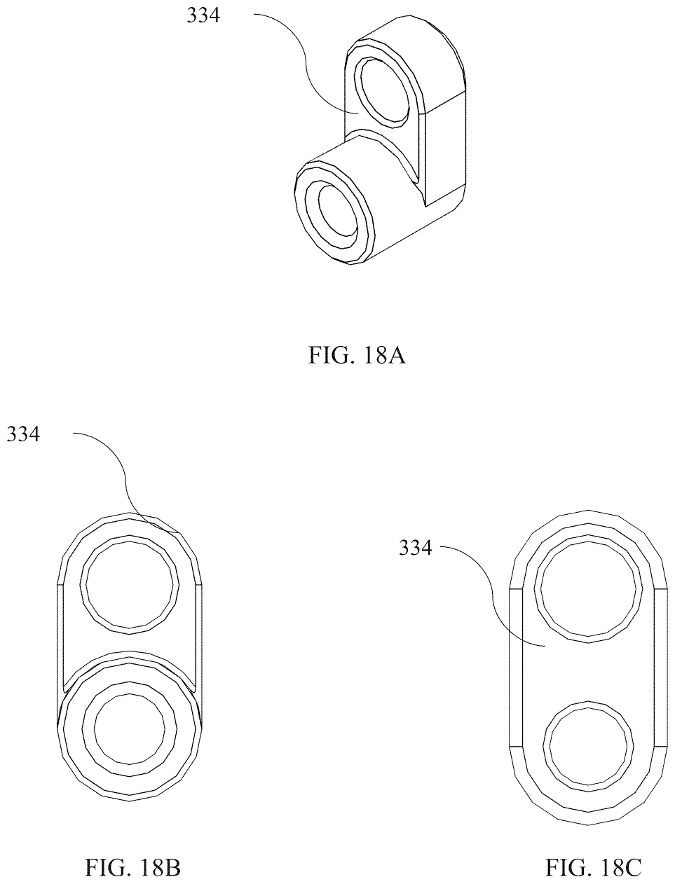

FIGS. 18A-18C show an oval drill bushing 334 which can be coupled to the driver side wall 308 and the passenger side wall 312. The oval drill bushing 334 can be interchangeable. The oval drill bushing 334 can include one or more apertures which can be used to couple the oval drill bushing 334 to the driver side wall 308 and/or the passenger side wall 312 with one or more dowels. An advantage of this embodiment is that it can eliminate the need for using a Picatinny rail insert (e.g., Picatinny rail insert 120) and a support dowel through the one or more apertures of the oval drill bushing 334 since the oval drill bushing 334 can provide support to a pistol frame blank. Another advantage of this embodiment is that the oval drill bushing 334 can rotate 180 degrees to provide support for different types of pistol frame blanks.

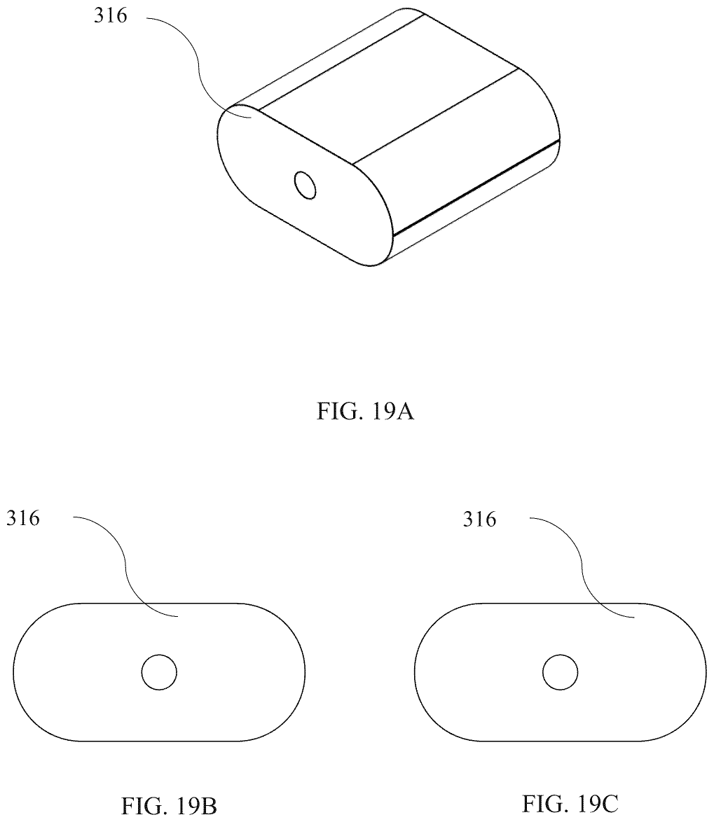

FIGS. 19A-9C show a trigger guard insert 316 which can be coupled to the modular jig 300. The trigger guard insert 316 can provide support for the pistol frame blank 104. The trigger guard insert 316 can have an aperture. The trigger guard insert 316 can be placed within an opening (e.g., trigger guard) within the pistol frame blank 104. The trigger guard insert 316 can be coupled with the driver side wall 308 and the passenger side wall 312.

FIGS. 20A-20E show a router milling support plate 340 which can couple to the driver side wall 308 and the passenger side wall 312. The router milling support plate 340 can be coupled to the modular jig 300 so that a router can mill out blocking tabs on the pistol frame blank 104 (e.g., various pistol frame blanks). The router milling support plate 340 can have one or more rectangular rails which can elevate a top platform of the router milling support plate 340 vertically away from a top shelf of a pistol frame blank.

Depending on the size and/or design of the pistol frame blank 104, a combination of the Picatinny rail insert 120 and the alignment guide pins (e.g., dowel bushings) can be used to provide support to the frame. For example, for one version of the pistol frame blank 104 the Picatinny rail insert 120 is used with the frame. In another example, the aperture located at the front end and dowel are coupled together and provide support for the pistol frame blank 104. In another example, the remaining apertures are coupled to a dowel to provide support to the pistol frame blank 104.

The modular jig 100 can be mounted on its side in a vise for a user to drill into the pistol frame blank 104 (e.g., drill 3 mm and/or 4 mm pin holes). Additionally, a user can then flip the modular jig 100 onto the opposite side to drill into the opposite side of the pistol frame blank 104. The modular jig 100 can also be clamped into a vice with the top of the pistol frame blank 104 facing up to secure the pistol frame blank 104 so that a user can mill off blocking tabs located on the top of the pistol frame blank 104. Additionally, the modular jig 100 can be clamped so that a user can mill out the half-circle blocking tab at the front and/or interior area of the frame.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include these features, elements and/or states.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

While the above detailed description may have shown, described, and pointed out novel features as applied to various embodiments, it may be understood that various omissions, substitutions, and/or changes in the form and details of any particular embodiment may be made without departing from the spirit of the disclosure. As may be recognized, certain embodiments may be embodied within a form that does not provide all of the features and benefits set forth herein, as some features may be used or practiced separately from others.

The methods which are described and illustrated herein are not limited to the sequence of acts described, nor are they necessarily limited to the practice of all of the acts set forth. Other sequences of acts, or less than all of the acts, or simultaneous occurrence of the acts, may be utilized in practicing embodiments of the invention(s).

It is to be understood that any range of values disclosed, taught, or suggested herein comprises all values and sub-ranges therebetween. For example, a range from 5 to 10 will comprise all numerical values between 5 and 10 and all sub-ranges between 5 and 10.

From the foregoing description, it will be appreciated that a novel approach for manufacturing partially complete firearm pistol frame blanks has been disclosed. While the components, techniques, and aspects of embodiments of the invention have been described with a certain degree of particularity, it is manifest that many changes may be made in the specific designs, constructions, and methodology herein above described without departing from the spirit and scope of this disclosure.

While a number of preferred embodiments of the invention and variations thereof have been described in detail, other modifications and methods of using for the same will be apparent to those of skill in the art. Accordingly, it should be understood that various applications, modifications, and substitutions may be made of equivalents without departing from the spirit of embodiments of the invention or the scope of the claims. Various modifications and applications of the embodiments of the invention may occur to those who are skilled in the art, without departing from the true spirit or scope of the embodiments of the invention. It should be understood that the invention(s) is not limited to the embodiments set forth herein for purposes of exemplification but is to be defined only by a fair reading of the appended claims, including the full range of equivalency to which each element thereof is entitled.

What is claimed is:

1. A modular jig for converting a pistol frame blank into a finished pistol frame, comprising:
a passenger side wall;
a driver side wall opposite the passenger side wall;
one or more indexable drill guides coupled to at least one of the passenger side wall and the driver side wall;
a trigger guard insert coupled to each of the passenger side wall and the driver side wall; and
one or more magazine catch inserts coupled to an interior side of at least one of the passenger side wall and the driver side wall;
wherein the trigger guard insert and the one or more magazine inserts are configured to locate the pistol frame blank to a drill guide.
